(19) United States
(12) Patent Application Publication
(10) Pub. No.: US 2026/0285284 A1
(43) Pub. Date: Sep. 24, 2026

(54) METHOD FOR CONTROLLING A MOTOR VEHICLE BRAKE SYSTEM IN CASE OF A FAULT

(71) Applicant: AUMOVIO Germany GmbH, Frankfurt am Main (DE)

(72) Inventors: Felix Alexander Fertig, Frankfurt am Main (DE); Eberhard Münz, Sandhausen (DE)

(73) Assignee: AUMOVIO Germany GmbH, Frankfurt am Main (DE)

(21) Appl. No.: 19/575,061

(22) Filed: Mar. 23, 2026

(30) Foreign Application Priority Data
Mar. 21, 2025 (DE) 10 2025 111 017.4

(51) Int. Cl. B60T 17/22; B60T 11/10; B60T 13/74

(52) U.S. Cl. CPC B60T 17/221; B60T 11/10; B60T 13/745; B60T 2220/04; B60T 2270/402; B60T 2270/403; B60T 2270/404; B60T 2270/82

(57) ABSTRACT

A method for controlling a motor vehicle brake system having a brake pedal unit with sensor arrangement for determining a driver braking demand and an electric pressure-providing device comprises determining a driver braking demand with a sensor arrangement for a brake pedal unit; activating an electric pressure-providing device on the basis of the driver braking demand in a first brake-by-wire operating mode corresponding to a fault-free case; monitoring pressure and volume of fluid provided for wheel brakes; and switching to a fallback mode operating mode or a second brake-by-wire operating mode on the basis of a system volume in the event of a fault.

### TECHNICAL FIELD

The embodiments relate to a method for controlling a motor vehicle brake system having a brake pedal unit with a sensor arrangement for determining a driver braking demand and to a corresponding a motor vehicle brake system.

### BACKGROUND

As a result of the decoupling of the driver from the wheel brakes in such brake-by-wire motor vehicle brake systems, faults in the brake system cannot be directly sensed by the driver. In such brake systems, the monitoring of the pressure and volume provided is therefore a decisive, if not the most important, safety factor. In known brake systems, therefore, a fault in the determination of the volume typically triggers a downgrading to the hydraulic fallback level, which is accompanied by severe restrictions of the deceleration capability.

### SUMMARY

It is therefore an object to provide a high functional capability of the motor vehicle brake system even in the event of a fault.

The object is achieved by a method, wherein, in the event of a fault, an operating mode is switched over, wherein either a fallback mode or a second brake-by-wire mode is switched on the basis of a system volume. The motor vehicle brake system therefore has at least three different operating modes, a first brake-by-wire mode, a second brake-by-wire mode and a fallback mode. Therefore, in the event of a fault, although the operating mode is switched over, brake-by-wire operation continues depending on the system volume. This means that pressure and for example by the same pressure-providing device as in the first brake-wire mode. Therefore, brake force boosting continues to be available. The monitoring of the pressure and volume provided comprises for example a determination of at least one pressure which can be measured directly or indirectly. This is for example a system pressure of the brake system, which is the pressure which prevails at the inlet valves on the input side. For this purpose, the brake system may have a system pressure sensor which is connected on the inlet side to the inlet valves and which measures the system pressure. Furthermore, the volume discharged into the wheel brakes can be determined, which is calculated from volume information of the pressure-providing device. A pV characteristic curve, i.e., a pressure-volume relationship of the brake system, can be used for the monitoring. This indicates how the pressure should change in the fault-free case at a specific volume delivered into the wheel brakes. If a measured relationship between pressure and volume deviates from this behavior by more than a tolerance threshold, a fault is assumed, a warning is issued accordingly, and measures are initiated. The sensor arrangement in the brake pedal may for example be a travel sensor, a force sensor and/or a pressure sensor, which may be arranged on a mechanically coupled hydraulic arrangement, in particular a master brake cylinder, or may be connected in terms of flow. The system volume is for example the volume available in the brake system without a brake fluid reservoir for building up pressure in the wheel brakes. This can be calculated, for example, from a sum of the volume situated in the wheel brakes and of the volume in the pressure-providing device.

In an embodiment, the pressure-providing device is a linear actuator. In the case of a linear actuator, for example for building up pressure, a piston is displaced axially into a hydraulic pressure compartment which is constructed in series with a rotation/translation gear. The motor movement of an electric motor is converted by the rotation/translation gear into an axial displacement of the piston.

An advancing movement of the linear actuator out of the rest position thereof into the pressure compartment displaces a brake fluid volume from the linear actuator via the open valves into the wheel brakes and thus brings about a pressure build-up. Conversely, the movement of the linear actuator back towards the rest position thereof leads to a reduction in pressure in the wheel brakes. A required system pressure is set by means of a suitable pressure regulator or a suitable pressure regulating system.

During normal operation, in the case of a power-assisted brake system of this type, the driver actuates a pedal simulator, wherein this pedal actuation is detected by pedal sensors, and a corresponding pressure setpoint for the linear actuator for actuation of the wheel brakes is determined.

In a further embodiment, the fault situation comprises an at least partial failure of the determination of volume information of the electric pressure-providing device. In the case of a linear actuator, the volume information may for example be the piston position which specifies, by means of the geometry, such as the piston surface and the maximum and minimum positions, how much volume is located in the linear actuator, how much can still be received and how much can still be discharged. The volume information is utilized for example for monitoring pressure and volume.

In a further embodiment, the fallback mode comprises a shutdown of the electric pressure-providing device and/or the provision of pressure and volume by means of a second pressure-providing device. In this way, the pressure-providing device in particular is protected from mechanical damage. If, for example, in the case of a linear actuator, the position determination of the piston fails, it could be driven with high energy against the front or rear end stop. This would result in a total failure with irreparable damage, which is avoided by the deactivation. Typical fault cases, on the other hand, can usually be rehabilitated without having to visit a workshop. This ensures that the full functionality of the brake system can be quickly restored. In order to nevertheless provide good deceleration capability, it may be envisaged that some other pressure-providing device is used for the pressure and volume supply of the wheel brakes.

In an embodiment, the second pressure-providing device is brake pedal-actuated and in particular does not provide any brake force boosting. Accordingly, it has, for example, no electric motor and no vacuum brake booster. The pressure is therefore built up purely by the muscle force of the driver. This is also referred to as hydraulic fallback level.

In a further embodiment, in order to switch over the operating mode, the system volume is determined from the last known volume information of the pressure-providing device, the wheel brake volume and outlet valve activities. The volume information specifies in particular the volume situated in the pressure-providing device, for example the linear actuator. The wheel brake volume can be determined from a wheel brake model, which indicates how much volume is present at a particular pressure in the wheel brake. Furthermore, consideration is given to which wheel valve activities have been carried out since the last known volume information. For example, it is determined how much volume has flowed out via the outlet valves by again using a wheel brake model and a valve model which indicates the volume flow based on the prevailing pressure difference. This volume is subtracted from the sum of the volume in the pressure-providing device and the wheel brakes. The volume flow via the outlet valves may in this case be determined continuously in the wheel pressure model, since a time greater than 10 ms can elapse between the last valid position of the linear actuator piston and the motor position error detected, and therefore ABS control operations can continue to be active.

The model wheel pressures/volumes can be different, as they can differ from each other in an ABS maneuver. Here, prior to the ABS maneuver (in the case of open inlet valves), the wheel pressure model is based on the system pressure sensor and calculates a volume flow across the valves from this attachment point as a function of the delta pressures at the inlet valve and outlet valve over the valve opening times. This volume flow leads to a change in volume in the wheel, which in turn is converted into a wheel model pressure by means of the pV characteristic curve.

In a further embodiment, in order to switch the operating mode, the system volume is compared with a volume limit value. If the system volume is larger than the volume limit value, the second brake-by-wire operating mode is used, otherwise the fallback mode. It is hereby ensured that sufficient volume is available for the pressure provision by means of the electric pressure-providing device.

In a further embodiment, the tolerances of the determination of the system volume are designed such that the system volume is systematically underestimated. For example, sizes that are not exactly known can be set to a value which is not in the center of the tolerance range but rather asymmetrically. The value can be placed on the edge of the tolerance range that corresponds to an underestimation, so that there can be no overestimation even in the extreme case. Therefore, it is possible for example for the clearance to be set to 0. When using a linear actuator, during fault-free use, there is a range which is provided for position overshoots, i.e., a distance between the piston position approached as the foremost point and the actual mechanical end stop. In the second brake-by-wire mode, this can then be fully utilized, but can be ignored when considering the system volume. In addition, a fixed offset value can be provided as a reserve.

In a further embodiment, volume-consuming functions are switched off in the second brake-by-wire operating mode. These are those functions which comprise a volume flow back into the reservoir, for example as a result of opening the outlet valves. This comprises for example a normal antilock control ABS and/or stability control ESC.

In another embodiment, in the second brake-by-wire operating mode, no additional brake fluid is drawn out of a brake fluid reservoir.

In a further embodiment, the pressure is limited to a pressure limit value in the second brake-by-wire operating mode. For example, the blocking pressure of the system can be selected as the pressure limit value. A blocking pressure is the pressure that causes the wheels to lock in normal conditions and on dry roads. The pressure limit value may be selected between 100 bar and 160 bar, for example between 120 and 140 bar.

In a further embodiment, it is provided that the volume limit value converted via a pV characteristic curve of the motor vehicle brake system corresponds to the pressure limit value. It is thus ensured that even at the maximum settable pressure a residual volume still remains in the pressure-providing device, and thus damage is avoided.

In a further embodiment, it is provided that the pressure limit value converted via a pV characteristic curve corresponds to the system volume. The pressure limit value is thus selected in such a way that it can just be achieved with the existing system volume. The second brake-by-wire operating mode thus has the maximum possible availability.

In a further embodiment, it is provided that the fault situation comprises an at least partial failure of a rotor position sensor of a synchronous machine of the first pressure-providing device, wherein, in the second brake-by-wire operating mode, the synchronous machine is activated without information from the rotor position sensor.

The object is additionally achieved by a computer program product which, when executed on a corresponding computing device, carries out an above-mentioned method. The computing device may for example be a control device of a correspondingly equipped brake system.

The object is also achieved by a hydraulic motor vehicle brake system having a brake pedal unit with sensor arrangement for determining a driver braking demand, an electric pressure-providing device, and a control unit which is configured to carry out an above-mentioned method.

Further features, advantages and possible uses will be apparent from the following description of exemplary embodiments and from the figures. Here, all the features described and/or illustrated in the figures are, in principle, the subject matter of the embodiments, individually or in any desired combination, irrespective of whether they are combined in the claims or the back-references thereof.

### BRIEF DESCRIPTION OF THE DRAWINGS

FIG. 1 shows an exemplary brake system.

### DETAILED DESCRIPTION

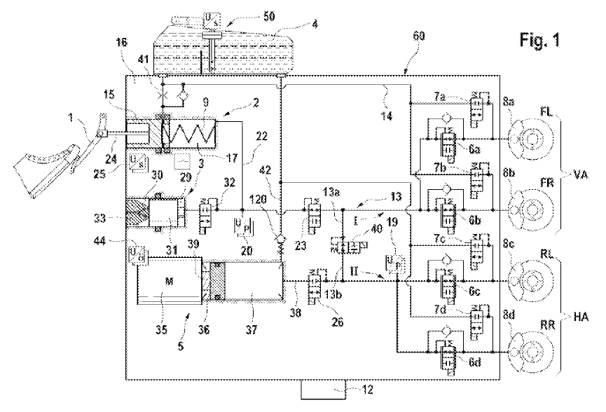

The brake system illustrated in FIG. 1 for a motor vehicle comprises four hydraulically actuatable wheel brakes 8a-8d. The brake system comprises a master brake cylinder 2 which can be actuated by means of an actuating or brake pedal 1, a travel simulator or a simulation device 3 which interacts with the master brake cylinder 2, a pressure medium reservoir 4 which is under atmospheric pressure, an electrically controllable pressure-providing device 5, and wheel valves, that is to say wheel-specific brake pressure modulation valves which are configured according to the example as inlet valves 6a-6d and outlet valves 7a-7d. A brake pedal with master brake cylinder may be regarded as a second pressure-providing device within the context of the embodiments.

Furthermore, the brake system comprises at least one electronic control and regulating unit 12 for controlling the electrically actuatable components of the brake system. The control and regulating unit 12 has, for example, at least two separate sub-units which regulate in each case some of the hydraulic units.

According to the example, the wheel brake 8a is assigned to the left front wheel (FL), the wheel brake 8b is assigned to the right front wheel (FR), the wheel brake 8c is assigned to the left rear wheel (RL), and the wheel brake 8d is assigned to the right rear wheel (RR).

The master brake cylinder 2 has, in a housing 16, a master brake cylinder piston 15, which delimits a hydraulic pressure chamber 17, and constitutes a single-circuit master brake cylinder 2. The pressure chamber 17 receives a restoring spring 9 which, with the master brake cylinder 2 unactuated, positions the piston 15 in a starting position. On the one hand, the pressure chamber 17 is connected to the pressure medium reservoir 4 via radial bores formed in the piston 15 and a corresponding pressure equalization line 41, wherein this connection can be shut off by a relative movement of the piston 15 in the housing 16. On the other hand, the pressure chamber 17 is connected by means of a hydraulic line section (also referred to as first feed line) 22 to a brake supply line 13 to which the inlet ports of the inlet valves 6a-6d are connected. The pressure chamber 17 of the master brake cylinder 2 is thus connected to all of the inlet valves 6a-6d.

According to the example, no hydraulic valve, for example no electrically or hydraulically actuatable valve and no check valve, is arranged in the pressure equalization line 41 or in the connection between the pressure chamber 17 and the pressure medium reservoir 4.

Alternatively, in the pressure equalization line 41 or between the master brake cylinder 2 and the pressure medium reservoir 4, a diagnostic valve, in particular one that is normally open, may be included, for example a parallel connection of a normally open diagnostic valve with a check valve that closes toward the pressure medium reservoir 4.

An isolation valve 23 is arranged between the feed line 22 connected to the pressure chamber 17 and the brake supply line 13, or the pressure chamber 17 is connected to the brake supply line 13 via the first feed line 22 having an isolation valve 23. The isolation valve 23 is designed as an electrically actuatable, for example normally open (SO), 2/2-way valve. The isolation valve 23 allows the hydraulic connection between the pressure chamber 17 and the brake supply line 13 to be shut off.

A piston rod 24 couples the pivoting movement of the brake pedal 1 resulting from a pedal actuation to the translational movement of the master brake cylinder piston 15, the actuation travel of which is detected by a travel sensor 25, which is for example of redundant design. In this way, the corresponding piston travel signal is a measure of the brake pedal actuation angle. It represents a braking demand of a vehicle driver, that is to say the driver braking demand.

A pressure sensor 20 connected to the first feed line 22 detects the pressure built up in the pressure chamber 17 as a result of a displacement of the piston 15. This pressure value can also be evaluated to characterize or determine the braking demand of the vehicle driver. As an alternative to a pressure sensor 20, use can also be made of a force sensor 20 for determining the braking demand of the vehicle driver.

According to the example, the simulation device 3 is of hydraulic design and coupled hydraulically to the master brake cylinder 2. The simulation device 3 has, for example, essentially a simulator chamber 29, a simulator rear chamber 30 and a simulator piston 31 which separates the two chambers 29, 30 from one another. The simulator piston 31 is supported on a housing by an elastic element 33 (e.g., simulator spring) which is arranged in the (for example, dry) simulator rear chamber 30. According to the example, the hydraulic simulator chamber 29 is connected to the pressure chamber 17 of the master brake cylinder 2 by means of a for example electrically actuatable, preferably normally closed simulator enable valve 32.

The brake system comprises, for each hydraulically actuatable wheel brakes 8a-8d, an inlet valve 6a-6d and an outlet valve 7a-7d which are hydraulically interconnected in pairs via central ports and are connected to the wheel brakes 8a-8d. The inlet valves 6a-6d are each connected in parallel with a check valve (not described in more detail) that opens toward the brake supply line 13. The outlet ports of the outlet valves 7a-7d are connected to the pressure medium reservoir 4 via a common return line 14.

The electrically controllable pressure-providing device 5 is designed as a hydraulic cylinder-piston arrangement or a single-circuit, electrohydraulic actuator or linear actuator, the piston 36 of which can be actuated by a schematically indicated electric motor 35 via a likewise schematically illustrated rotation/translation gear 39. The piston 36 delimits the single pressure space 37 of the pressure-providing device 5. A merely schematically indicated rotor position sensor which serves to detect the rotor position of the electric motor 35 is denoted by reference numeral 44. The electric motor of the linear actuator is designed as a brushless synchronous motor and uses the rotor position sensor or motor position sensor 44 for the correct actuation of the individual motor phases.

A line section (also referred to as second feed line) 38 is connected to the pressure space 37 of the electrically controllable pressure-providing device 5. The feed line 38 is connected to the brake supply line 13 via an electrically actuatable, preferably current-less closed, sequence valve 26. The sequence valve 26 allows the hydraulic connection between the pressure space 37 of the electrically controllable pressure-providing device 5 and the brake supply line 13 (and thus the inlet ports of the inlet valves 6a-6d) to be opened and shut off in a controlled manner.

The actuator pressure produced by the action of force of the piston 36 on the pressure medium enclosed in the pressure space 37 is fed into the second feed line 38. In a "brake-by-wire" operating mode, for example the first brake-by-wire operating mode in a fault-free state of the brake system, the feed line 38 is connected to the brake supply line 13 via the sequence valve 26. In this way there occurs, during normal braking, a wheel brake pressure buildup and pressure reduction for all the wheel brakes 8a-8d as a result of the forward and backward movement of the piston 36 between a front end position and a rear end position. Here, all the inlet valves may be open, such that the same brake pressure is built up jointly at the wheel brakes of the front axle and of the rear axle.

In the case of a pressure reduction by backward movement of the piston 36, the pressure medium previously displaced from the pressure space 37 of the pressure-providing device 5 into the wheel brakes 8a-8d flows back again into the pressure space 37 in the same way.

Alternatively, wheel brake pressures which differ in a wheel-specific manner can be simply set by means of the inlet and outlet valves 6a-6d, 7a-7d. In the case of a corresponding pressure reduction, the pressure medium fraction discharged via the outlet valves 7a-7d flows via the return line 14 into the pressure medium reservoir 4.

Pressure medium can be drawn into the pressure space 37 ("refilled") by a backward movement of the piston 36 while the sequence valve 26 is closed, by virtue of the fact that pressure medium can flow out of the reservoir 4 into the actuator pressure space or pressure space 37 via the line 42 which has a check valve 53 which opens in a flow direction to the actuator 5.

In the brake supply line 13 there is arranged an electrically actuatable, normally open circuit isolation valve 40 by means of which the brake system is divided into two hydraulic partial circuits. The brake supply line 13 is divided into a first line section 13a, which is connected (via the isolation valve 23) to the master brake cylinder 2, and a second line section 13b in the second hydraulic partial circuit, which is connected (via the sequence valve 26) to the pressure-providing device 5. The first line section 13a is connected to the inlet valves 6a, 6b of the wheel brakes 8a, 8b, and the second line section 13b is connected to the inlet valves 6c, 6d of the wheel brakes 8c, 8d.

With the circuit isolation valve 40 opens, the brake system is of single-circuit design. By closing the circuit isolation valve 40, the brake system, for example controlled in a situation-appropriate manner, can be divided or split up into two hydraulic part circuits, the brake circuits I and II. Here, in the first brake circuit I, the master brake cylinder 2 is connected (via the isolation valve 23) to only the inlet valves 6a, 6b of the wheel brakes 8a, 8b of the front axle VA, and, in the second brake circuit II, the pressure-providing device 5 is connected (with the sequence valve 26 opened) to only the wheel brakes 8c and 8d of the rear axle HA.

With the circuit isolation valve 40 open, the inlet ports of all the inlet valves 6a-6d can be supplied by means of the brake supply line 13 with a pressure which, in the first brake-by-wire operating mode, corresponds to the brake pressure which is provided by the pressure-providing device 5. In a fallback mode, the brake supply line 13 can be charged with the pressure of the pressure chamber 17 of the master brake cylinder 2.

The brake system comprises a level-measuring device 50 for determining a pressure medium level in the pressure medium reservoir 4. A situation recognition for circuit separation by means of the circuit isolation valve 40 occurs via the level-measuring device 50.

According to the example, the hydraulic components and hydraulic units, namely the master brake cylinder 2, the simulation device 3, the pressure-providing device 5, the valves 6a-6d, 7a-7d, 23, 26, 40 and 32 and also the hydraulic connections including the brake supply line 13, are arranged together in a hydraulic control and regulating unit 60 (HCU). The hydraulic control and regulating unit 60 is assigned the electronic control and regulating unit (control system) 12. The hydraulic and electronic control and regulating unit 60, 12 may be designed as one unit (HECU)

The brake system comprises a pressure sensor 19 or system pressure sensor for detecting the pressure provided by the pressure-providing device 5. Here, the pressure sensor 19 is arranged behind the sequence valve 26 as seen from the pressure chamber 37 of the pressure-providing device 5.

The synchronous motor drive of the linear actuator 5 requires motor angle information in order to be able to switch the commutation field correctly and to be able to provide the optimum of speed, acceleration and maximum pressure. In the event of failure of the rotor position sensor 44, the linear actuator 5 cannot reliably maintain synchronous operation.

Accordingly, the brake system can then be operated in at least two different degraded operating modes. In a fallback mode, which is also referred to as hydraulic fallback level, master brake cylinder 2 is separated from the simulator 3 by closure of the simulator valve 32 and is instead connected to the wheel brakes 8 via an open isolation valve 23. Here, the sequence valve 26 is closed and the linear actuator 5 is switched off. A braking effect is therefore built up purely by the muscle force of the driver.

In an alternative case, a second brake-by-wire operating mode is used and the linear actuator is merely degraded, wherein the commutation field is operated at a reduced speed and with a higher torque in the absence of a sensed angular position. This means a reduced maximum volumetric flow that can be provided by the linear actuator. Accordingly, the choice as to which operating mode is used is determined on the basis of the system volume.

While the brake system is running without faults, the position of the piston 36 of the linear actuator 5 is continuously determined by means of the data from the rotor position sensor 44. In this way, by means of the geometry of the linear actuator 5, it is known how much volume of brake fluid is located in the linear actuator and thus also how much volume has been displaced into the wheel brakes 8. This information is used, together with the hydraulic pressure which is set, as is measured by the system pressure sensor 19, to monitor the brake system. For this purpose, the pressure-volume behavior is compared with a desired behavior from a pressure-volume characteristic curve in order to detect deviations from a standard behavior.

If the rotor position sensor 44 now fails, the position information of the piston 36 is also lost. To determine the system volume, the last known position of the piston 35 is now used, which forms a last known piece of volume information for the linear actuator and indicates the volume situated in the linear actuator 5 at this time. Furthermore, the volume in the wheel brakes is determined at this time by performing a conversion into the volume situated therein by means of the individual wheel pressures in the wheel brakes 8 and corresponding characteristic curves. The sum of these two values forms the system volume at that time. To determine the current system volume, the volume that has flowed out via the outlet valves 7 since then is subtracted from this value. For this purpose, the outlet valve activities since this time are considered and, by means of the wheel pressures and a model for the outlet valves 7, it is calculated what volume has flowed out into the reservoir 4 in a manner dependent on the prevailing pressure in the time period in which the outlet valves were open.

This system volume at the present time indicates the brake fluid volume which is currently situated in the brake system and is available for pressure build-up without a further suction cycle. Whether this volume is sufficient for reliable operation of the brake system is determined by comparison with a volume limit value. If the system volume is larger, the motor vehicle brake system can be safely operated in the second brake-by-wire mode.

In this second brake-by-wire operating mode, pressure continues to be built up by the linear actuator 5, which is activated on the basis of the driver braking demand. In this case, however, the volume-consuming functions ABS and ESC are switched off and no suction cycle is carried out. Furthermore, the maximum adjustable pressure is limited to 120 bar. Since the volume limit value is selected such that the system volume is sufficient for a pressure build-up to 120bar, the piston 35 of the linear actuator 5 cannot reach its end stop. Damage to the system is therefore ruled out even without information on the position of the piston 35.

What is claimed is:

1. A method for controlling a motor vehicle brake system, comprising:
determining a driver braking demand with a sensor arrangement for a brake pedal unit;
activating an electric pressure-providing device on the basis of the driver braking demand in a first brake-by-wire operating mode corresponding to a fault-free case;
monitoring pressure and volume of fluid provided for wheel brakes; and
switching to a fallback mode operating mode or a second brake-by-wire operating mode on the basis of a system volume in the event of a fault.

2. The method according to claim 1, wherein the electric pressure-providing device is a linear actuator.

3. The method according to claim 1, wherein the fault situation comprises an at least partial failure of the determination of volume information of the electric pressure-providing device.

4. The method according to claim 1, wherein the fallback mode comprises a shutdown of the electric pressure-providing device and/or the provision of pressure and volume with a second pressure-providing device.

5. The method according to claim 4, wherein the second pressure-providing device is brake pedal-actuated and does not provide any brake force boosting.

6. The method according to claim 1, further comprising determining the system volume from the last known volume information of the electric pressure-providing device, the wheel brake volume and outlet valve activities in order to switch over the operating mode.

7. The method according to claim 1, wherein, further comprising comparing the system volume with a volume limit value, wherein the second brake-by-wire operating mode is used when the system volume is greater than the volume limit value, and otherwise switching the operating mode to the fallback mode.

8. The method according to claim 1, wherein tolerances for the determination of the system volume are set such that the system volume is systematically underestimated.

9. The method according to claim 1, wherein volume-consuming functions are switched off in the second brake-by-wire operating mode.

10. The method according to claim 1, wherein in the second brake-by-wire operating mode, no additional suction of brake fluid is drawn out of a brake fluid reservoir.

11. The method according to claim 1, wherein the pressure is limited to a pressure limit value in the second brake-by-wire operating mode.

12. The method according to claim 11, wherein the volume limit value corresponds to the pressure limit value converted via a pV characteristic curve of the motor vehicle brake system.

13. The method according to claim 11, wherein the pressure limit value corresponds to the system volume converted via a pV characteristic curve.

14. The method according to claim 1, wherein the fault situation comprises an at least partial failure of a rotor position sensor of a synchronous machine of the first pressure-providing device, wherein, in the second brake-by-wire operating mode, the synchronous machine is controlled without information from the rotor position sensor.

15. A hydraulic motor vehicle brake system comprising:
a brake pedal unit;
a sensor arrangement for determining a driver braking demand from the brake pedal unit;
an electric pressure-providing device; and
a control unit with instructions for:
determining the driver braking;
activating the electric pressure-providing device on the basis of the driver braking demand in a first brake-by-wire operating mode corresponding to a fault-free case;
monitoring pressure and volume of fluid provided for wheel brakes; and
switching to a fallback mode operating mode or a second brake-by-wire operating mode on the basis of a system volume in the event of a fault.
